(19) United States
(12) Patent Application Publication
(10) Pub. No.: US 2008/0232364 A1
(43) Pub. Date: Sep. 25, 2008

(54) DEVICE FOR COALESCING MESSAGES AND METHOD THEREOF

(75) Inventor: Harlan T. Beverly, McDade, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: BIGFOOT NETWORKS, INC., Austin, TX (US)

(21) Appl. No.: 12/053,413

(22) Filed: Mar. 21, 2008

Related U.S. Application Data
(60) Provisional application No. 60/896,828, filed on Mar. 23, 2007.

(51) Int. Cl. H04L 12/56

(52) U.S. Cl. 370/389

(57) ABSTRACT

A method of communicating messages between endpoints in a data processing system includes coalescing two or more messages into a single packet and communicating the packet. Each of the messages can be associated with a different communication protocol. In addition, each of the messages can be targeted for communication to a different communication port. At the destination endpoint, the packet is de-coalesced, whereby each message is extracted from the packet and provided to the associated port. By coalescing multiple messages into a single packet, even where the messages are associated with different communication protocols or different communication ports, packets can be formed closer to an optimum size, thereby providing for more efficient communication between endpoints.

### CROSS REFERENCE TO RELATED APPLICATIONS

This application claims priority to U.S. Provisional Patent Application No. 60/896,828, entitled “METHOD AND SYSTEM FOR COALESCING MESSAGES FROM ONE ENDPOINT TO ANOTHER ENDPOINT ON A BUS,” filed on Mar. 24, 2007, which is assigned to the current assignee hereof and is incorporated herein by reference in its entirety.

### FIELD OF THE DISCLOSURE

The present disclosure relates to data processing systems and more particularly to communications between endpoints in a data processing system.

### BACKGROUND

Data processing systems sometimes employ two or more endpoints that communicate via a shared bus or network. For example, a data processor of the system can communicate with a peripheral module, such as a network interface or graphics processor, via a bus. Communications between the endpoints can be implemented by placing messages (i.e. communications content) into a packet and communicating the packet via the shared bus or network. Formation and transmission of a packet is typically based on compliance with a specified protocol associated with the bus or network, such as PCI, PCI-X, or Ethernet protocol. The protocol is typically associated with an optimum packet size that provides for most efficient communication of information. However, the messages to be communicated over the shared bus or network may be smaller than the optimum packet size, resulting in formation of small packets and reduced efficiency of communication. Accordingly, an improved method and system for communication of messages would be useful.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a data processing system in accordance with one embodiment of the present disclosure.

FIG. 2 is a block diagram of a set of messages and associated packet in accordance with one embodiment of the present disclosure.

FIG. 3 is a block diagram of a data processing system in accordance with another embodiment of the present disclosure.

FIG. 4 is a block diagram illustrating software layers for a data processing system in accordance with one embodiment of the present disclosure.

FIG. 5 is a flow diagram illustrating a method of coalescing messages in accordance with one embodiment of the present disclosure.

FIG. 6 is a flow diagram illustrating a method of de-coalescing messages in accordance with one embodiment of the present disclosure.

FIG. 7 is a flow diagram illustrating a method of coalescing messages in accordance with one embodiment of the present disclosure.

FIG. 8 is a block diagram of a data processing system in accordance with one embodiment of the present disclosure.

FIG. 9 is a block diagram of a link interface in accordance with one embodiment of the present disclosure.

The use of the same reference symbols in different drawings indicates similar or identical items.

### DETAILED DESCRIPTION

A method of communicating messages between endpoints in a data processing system includes coalescing two or more messages into a single packet and communicating the packet. Each of the messages can be associated with a different communication protocol. In addition, each of the messages can be targeted for communication to a different communication port. At the destination endpoint, the packet is de-coalesced, whereby each message is extracted from the packet and provided to the associated port. By coalescing multiple messages into a single packet, even where the messages are associated with different communication protocols or different communication ports, packets can be formed closer to an optimum size, thereby providing for more efficient communication between endpoints.

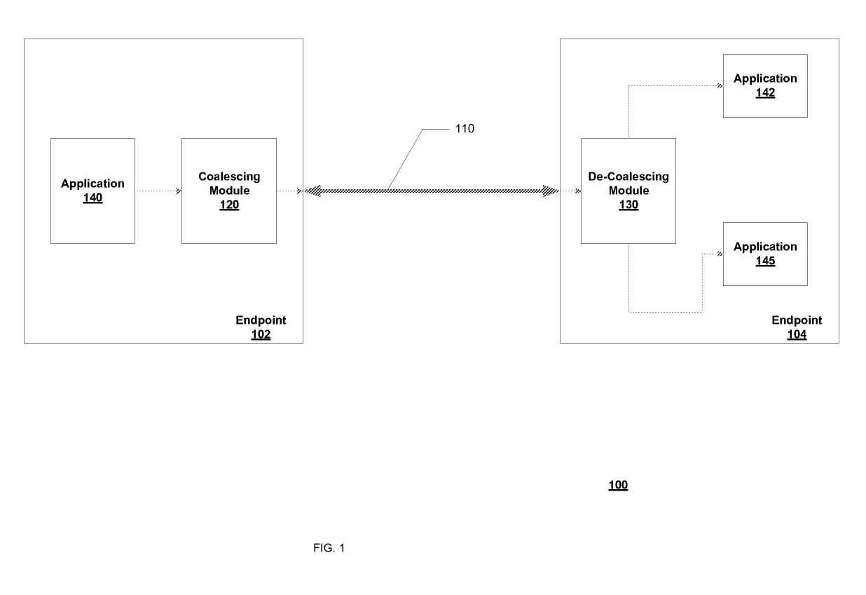

Referring to FIG. 1, a block diagram of a particular embodiment of a data processing system 100 is illustrated. The data processing system 100 includes endpoints 102 and 104. As used herein, an endpoint refers to a module of a data processing system that is one end of a connection for communication of packets. Thus, an endpoint is a portion of the data processing system that can create messages for communication, or receive and process those messages. An endpoint can therefore be a processor, peripheral module, computer device, and the like.

The endpoints 102 and 104 are connected via a link 110, which provides a physical layer for communication of packets between the endpoints. Accordingly, in a particular embodiment the link 110 is a bus, such as an internal system bus. In another embodiment, the link 110 can be a network, such as a local area network, a wide area network, and the like. The link 110 is associated with a particular packet communication protocol, such as PCI, PCI Express (PCI-X), SCSI, Infiniband, Ethernet, and the like.

The endpoint 102 includes an application 140 and a coalescing module 120. The application 140 can be any application that can form messages for communication to another endpoint. For example, the application 140 can be a web browser, chat program, peer-to-peer communication program, game program, productivity software, and the like. The application 140 is configured to form messages for communication to the endpoint 104, and provide those messages to the coalescing module 120. As used herein a message refers to data provided by an application for communication to an endpoint.

In the illustrated embodiment, the coalescing module 120 is a software module configured to coalesce messages provided by the application 140 into a coalesced message suitable for incorporation into a communication packet. In one embodiment, the coalescing module 120 coalesces messages until the coalesced message will result in a communication packet at or near an optimum size for the link 110. As used herein, an optimum size refers to a size association with a communication protocol that allows for maximum efficiency of communication via the protocol. In another embodiment, the coalescing module 120 coalesces any messages received in a specified period of time up to a maximum size, with the maximum size based on a maximum size of the communication protocol of the link 110.

After forming the coalesced message, the coalescing module 120 can form a packet including the coalesced message for communication via the link 110. In another embodiment, a different software or hardware module (not shown) of the endpoint 102 receives the coalesced message from the coalescing module 120 and forms a packet including the coalesced message.

In the illustrated embodiment of FIG. 1, the coalesced message can include messages associated with different communication protocols. For example, in one embodiment the coalesced message includes messages associated with different transport, network, or application layer protocols, such as Transmission Control Protocol (TCP), User Datagram Protocol (UDP), Real-Time Transport Protocol (RTP), Signaling Connection and Control Part (SCCP), Sequenced Packet Exchange (SPX), Stream Control Transmission Protocol (SCTP), Network File System (NFS), Server Message Block (SMB), IPv4, IPv6, IPSec, Secure Sockets Layer (SSL), Internetwork Packet Exchange (IPX), Connectionless Networking Protocol (CLNP), any number of standard or custom reliability protocols which are encapsulated by UDP such as video game protocols and video protocols, and the like. In addition, each message in the coalesced message can be associated with protocols having different security features. Thus, one of the messages can be associated with a reliable protocol, such as TCP, while another of the messages is associated with an unreliable protocol, such as UDP. Further, the coalesced messages can be associated with protocols reflecting different compression formats, such as compressed TCP or compressed UDP. Moreover, each message in the coalesced message can be targeted to a different communication port at the endpoint 104. Generally any different protocol can be combined with itself or others at the message level using the coalescer. By allowing a coalesced message to be associated with any port or communication protocol, the coalescing module increases the likelihood that a packet can be formed closer to the optimum packet size for the link 110, thereby improving efficiency of communication between the endpoints 102 and 104.

In the case where an unreliable protocol is being mixed with a reliable protocol, the reliable connection to the endpoint could be used to coalesce the unreliable protocol message without need of maintaining message order. However, in the case where reliable or ordered messages are to be coalesced with other reliable or ordered messages, it may be desirable to maintain message order for all connections even when coalescing.

One method of ensuring that message order is maintained when two connections are being coalesced is to ensure that all reliable or ordered messages being coalesced always use the same connection for transmission. For example, if one connection is associated with a TCP protocol and another connection is associated with a ‘reliable ordered’ UDP protocol the reliable ordered UDP messages could always be sent on the TCP connection whether coalescing was possible or not. Since TCP ensures message order, all the UDP messages also contain reliability and orderedness. In some cases it is desirable to begin coalescing messages at some time after both connections have sent some messages. In this case, the connection that is to be coalesced from (in this example the reliable ordered UDP connection), may not coalesce until the final message sent using that connection has been acknowledged as received.

Another method of ensuring that message order is maintained when two connections are being coalesced is to add a message order header to all message protocols (when they are being coalesced and when they are not being coalesced). In this way, the de-coalescing module can identify which messages were sent first regardless of the connection used to send it.

The endpoint 104 includes a de-coalescing module 130 and applications 140 and 145. The de-coalescing module 130 is a software module configured to extract coalesced messages received via the link 110. In particular, the de-coalescing module separates each individual message from a received coalesced message. In one embodiment, the de-coalescing module 130 is also configured to process packets received via the link 110 and extract a coalesced message from a received packet. In another embodiment, a different software or hardware module (not shown) extracts a coalesced message from a received packet and provides it to the de-coalescing module 130.

In the illustrated embodiment of FIG. 1, the de-coalescing module 130 is further configured to provide the separated messages to the applications 142 and 145 based upon the port number associated with each message. For example, the application 140 can be associated with a first communication port and the application 145 associated with a second communication port. Thus, the de-coalescing module can determine, based on a header associated with each separated message, which port is associated with each message, and route the message to the application associated with the determined port. Thus, all separated messages associated with the first port are provided to the application 142 and all separated messages associated with the second port can be provided to the application 145. In another embodiment, the de-coalescing module 130 provides the separated messages to another software module (not shown) which routes each message to the appropriate application based upon the port associated with the message. This allows the de-coalescing module 130 to be integrated with existing communication modules that route messages and perform other functions, without re-design of the existing communication modules.

As described above, each packet communicated via the link 110 can include messages associated with different protocols. Accordingly, the separated messages provided by the de-coalescing module 130 will reflect the individual connections associated with each message. In addition, the applications 142 and 145 will process the received messages according to the connection associated with each message. Thus, for example, a single received packet can include two messages targeted to application 140, with a first message associated with a TCP protocol connection and a second message associated with an encrypted unreliable UDP protocol connection. The de-coalescing module 130 will separate the messages in the received packet and provide the separated messages to the application 140 on their respective connections.

It will be appreciated that although for purposes of discussion the embodiment of FIG. 1 has been described with respect to communications from the endpoint 102 to the endpoint 104, communication between the endpoints can be bi-directional. Thus, the endpoint 104 can include a coalescing module to coalesce messages and communicate the coalesced messages to the endpoint 102 by sending a packet including the coalesced messages via the link 110. Further, the endpoint 102 can include a de-coalescing module to extract coalesced messages from the packet and provide the messages to the associated target application.

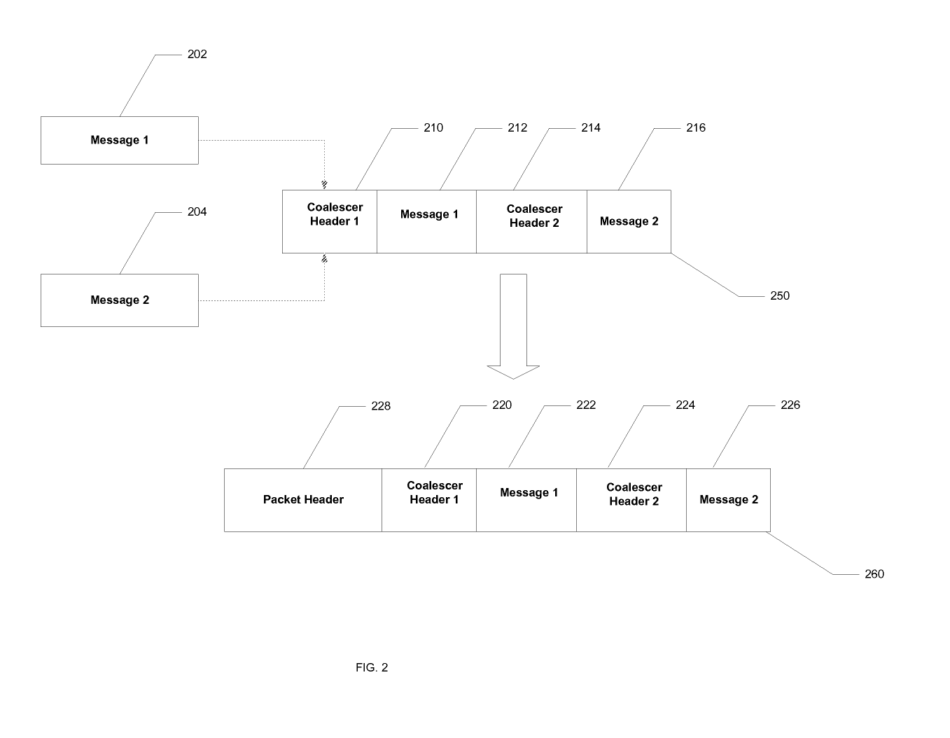

The operation of the data processing system 100 can be better understood with reference to FIG. 2, which illustrates a particular embodiment of a set of messages and an associated packet. In particular, FIG. 2 illustrates a message 202 and a message 204, including content labeled “Message 1” and “Message 2” respectively. The message 202 and message 204 are provided by the application 140 of FIG. 1 to the coalescing module 120. In an embodiment, the message 202 and message 204 are associated with different communication protocols. For example, the message 202 can be associated with a compressed UDP protocol while the message 204 is associated with a secure TCP protocol.

In response to receiving the messages 202 and 204, the coalescing module 120 of FIG. 1 forms a coalesced message 250, which includes message header information 210 and 214 and payload information 212 and 216. As illustrated, the payload information 212 and 216 includes the message information associated with the message 202 and message 204 respectively. The message header information 210 includes control information associated with the payload information 212. In particular, the header information can identify the communication protocol for the associated message information. Thus, if the message 202 is associated with a secure UDP protocol, the message header information 210 can include information indicating that protocol. The message header information can include one or more fields to indicate the protocol. For example, one field can indicate a general protocol type, such as UDP or TCP, a second field can indicate a security feature, such as secure or unsecure, and another field can indicate a compression feature, such as compressed or uncompressed. The header information 214 can include similar protocol information for the payload 216.

The message header information 210 and 214 can also include other information for the associated data payload, including information delimiting the amount of information included in the associated data payload. This allows the data payloads 212 and 216 to be of different sizes, so that the coalesced message 250 includes information reflecting messages of different and varying size. In addition, the message header information 210 and 214 can indicate a port number associated with the data payloads. Accordingly, the coalesced message 250 can include messages targeted to different destination ports.

The message header information 210 and 214 can also include other information for the associated data payload, including information indicating the order of the messages relative to other messages sent previously or yet to be sent. This allows the data payloads 212 and 216 to be maintain their order with respect to other messages sent but not necessarily with respect to each other.

The coalescing module 120 of FIG. 1, or other hardware or software module (not shown) forms a packet 260 based on the coalesced message 250. The packet 260 is configured for communication via the link 110 (FIG. 1) based on the protocol associated with the link. The packet 260 therefore includes packet header information 228, as well as message header information 220 and 224 and data payload information 222 and 226. In the illustrated embodiment, the message header information 220 and 224 is identical to the message header information 210 and 214, while the data payload information 222 and 226 is identical to the data payload information 212 and 216, respectively, of the coalesced message 250. Accordingly, the data payload information 222 and 226 respectively reflect the messages 202 and 204. The packet header 228 includes header information for the communication protocol associated with the link 110, such as address information, size information, and the like.

In the embodiment of FIG. 1, the endpoint 104 receives the packet 260. The de-coalescing module 130 or other hardware or software module extracts the coalesced message 250 from the packet 260. In addition, the de-coalescing module accesses the message header information 210 and 212 to separate the messages 202 and 204 from the coalesced message 250. For example, the de-coalescing module 130 can use the header information 210 to identify the size and limits of the data payload 212 in order to form the message 202. In addition, the de-coalescing module 130 can access port information in the message header information 210 and 214 to route each of the messages 202 and 204 to the application associated with the indicated port.

In some situations it is desirable to specify whether coalescing should be allowed or not allowed on a global basis or on a connection by connection basis. For example, in an embodiment the coalescing module can be set to one of a plurality of operating modes. In one mode coalescing of any and all connections to the same destination endpoint is allowed. In another mode coalescing for all connections is disallowed. In still another mode, some specified connections are allowed to be coalesced with a set of specified connections, and are disallowed from being coalesced with another set of specified connections. In and embodiment, the application 140 can send information to the coalescing module 120 indicating the desired coalescing mode

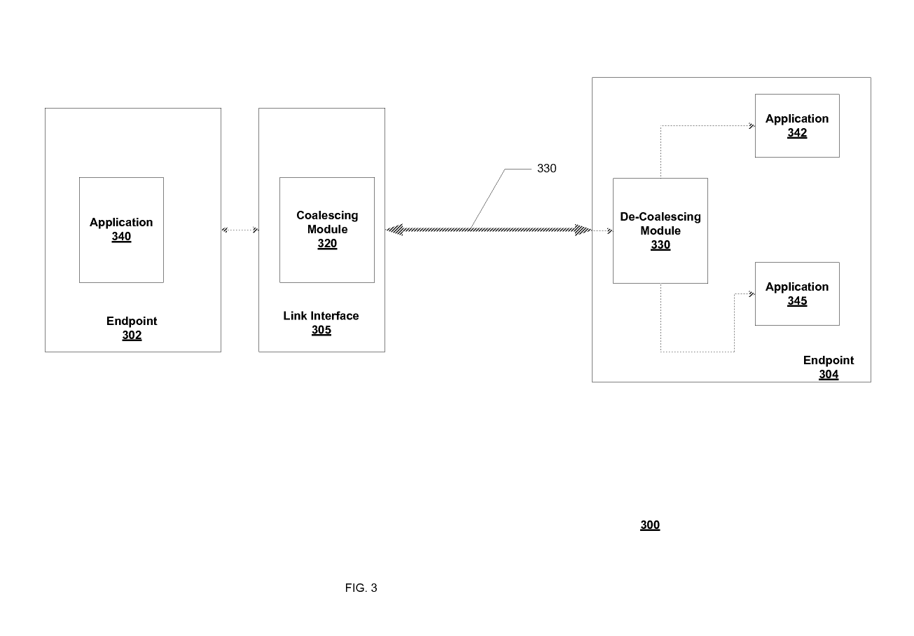

Referring to FIG. 3, a block diagram of a particular embodiment of a data processing system 300 is illustrated. The data processing system 305 includes endpoints 302 and 304, and a link interface 305. The link interface 305 is connected to the endpoint 302 and a link 330, while the endpoint 304 is also connected to the link 330. The endpoint 302 includes an application 340. The link 305 includes a coalescing module 320. The endpoint 304 includes a de-coalescing module 330, as well as applications 340 and 345.

The link interface 305 is a hardware module configured to receive messages from the endpoint 302 and to form packets based on those message for communication to the endpoint 304 via the link 330. The link interface 305 can be a bus interface module, a network interface module (e.g. a network card) and the like.

The data processing system 300 is configured to communicate messages from the endpoint 302 to the endpoint 304 in similar fashion to that described above with respect to FIGS. 1 and 2. However, in the illustrated embodiment of FIG. 3, the coalescing module 320 is located at the link interface 305. Accordingly, the coalescing module 320 forms messages received from the endpoint 302 into coalesced messages described above. By performing this function at the link interface 305, the processing load at the endpoint 302 is reduced. In addition, it will be appreciated that although for purposes of discussion the link interface 305 is illustrated as executing the coalescing module 320, in other embodiments the same or different link interface could execute the de-coalescing module 330, or another de-coalescing module (not shown) for packets communicated by the endpoint 304.

The coalescing module 320 can operate in one of a number of modes, whereby coalescing is provided for all, none, or a subset of connections as described above. The application 340 can set the coalescing mode of the coalescing module 320 by sending information to the link interface 305 via a standard hardware interface, such as a device driver (not shown) and the like.

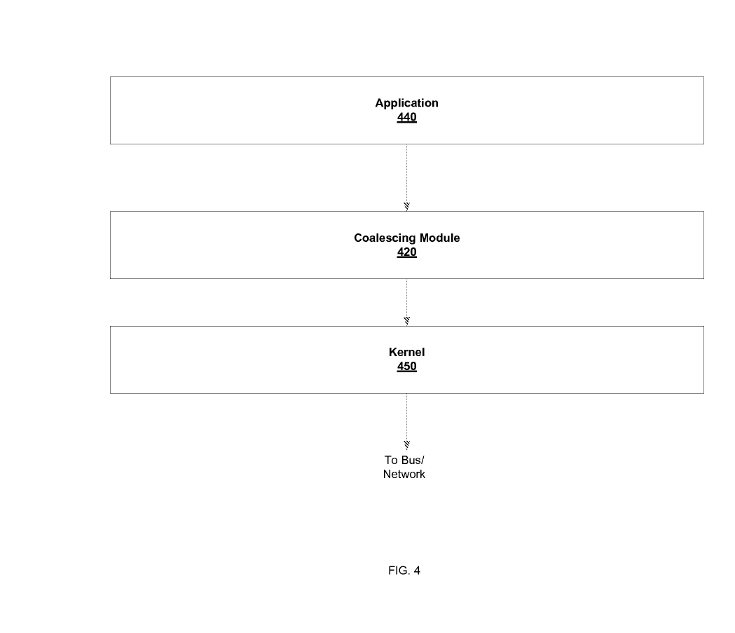

Referring to FIG. 4, a block diagram of a software topology 400 is illustrated, include an application 440, corresponding to the application 140 of FIG. 1, a coalescing module 420, corresponding to the coalescing module 120 of FIG. 1, and a kernel 450. The kernel 450 is an operating system kernel configured to manage interactions between the endpoint 102 and the link 110. Thus, the kernel 450 can be configured to receive messages, form those messages into packets, and place the packets into a network stack or other buffer for communication. The kernel 450 can also manage the network stack, ensuring that packets in the stack are communicated via the link 450. Further, the kernel 450 can be configured to receive packets via the link 450, to extract messages from the received packets, and to provide the extracted messages.

In the illustrated embodiment, the application 440 provides messages for transmission via the link 110. The messages are targeted by the application 440 to the kernel 450 for transmission. However, in the illustrated example, the coalescing module 420 is a layered service provider or other software module configured to intercept messages targeted to the kernel 450, and further configured to coalesce the intercepted messages into a coalesced message. The coalescing module provides the coalesced message to the kernel 450 for formation into a packet and communication via the link 110.

It will be appreciated that the de-coalescing module 130 can also be configured as a layered service provider or other software module interposed between an application layer and a kernel. The de-coalescing module 130 can be configured to intercept coalesced messages provided by the kernel 450, to separate the coalesced message into individual messages, and provide the individual message to the associated applications (e.g. to the applications indicated by a port number associated with each message).

Thus, in the illustrated embodiment of FIG. 4, the coalescing module 420 is a software module inserted between the application 440 and the kernel 450. This allows coalescing of messages, including messages associated with different communication protocols, without redesign of either the application 440 or the kernel 450.

The coalescing module 420 can operate in one of a number of modes, whereby coalescing is allowed for all, none, or a subset of connections as described above. The application 440 can set the coalescing mode of the coalescing module 420 by sending information to the coalescing module via standard software messaging protocols, such as a socket, a pipe, and the like.

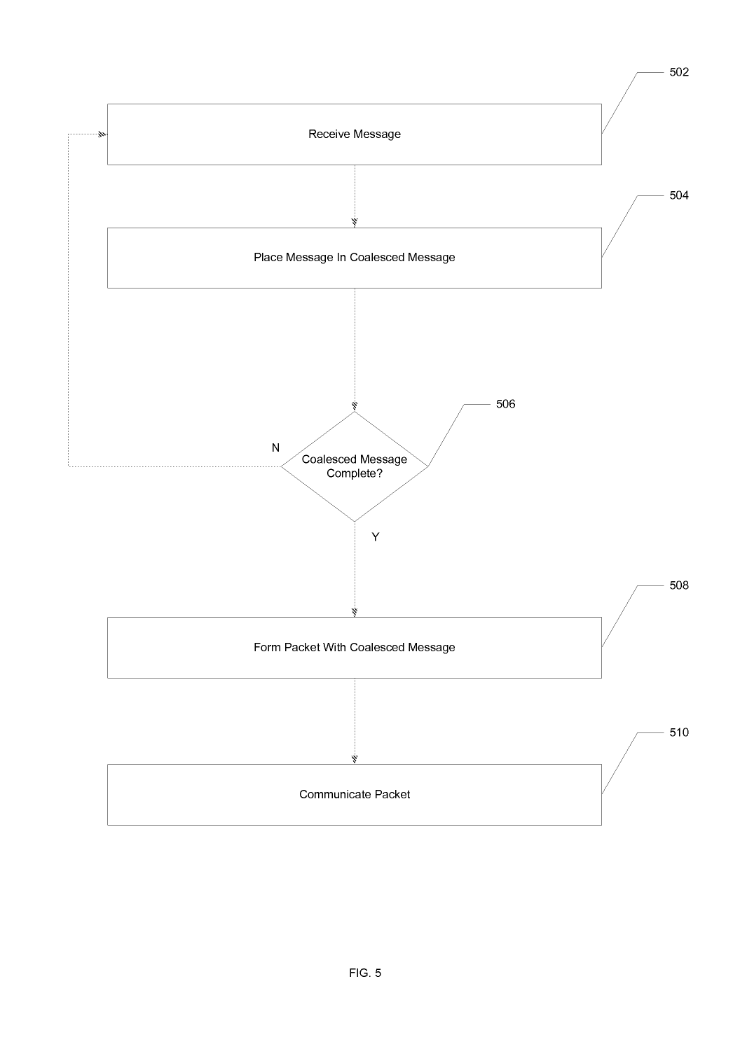

Referring to FIG. 5, a flow diagram of a particular embodiment of a method of coalescing messages is illustrated. At block 502 a message is received from an application. At block 504 the message is placed in a coalesced message. A message header for the message can be formed to delimit the message content in the coalesced message, as well as to identify particular attributes of the message, such as a communication protocol and the like.

At block 506, it is determined whether the coalesced message is complete. In an embodiment, this determination is based on the size of the coalesced message. For example, the coalesced message can be determined to be complete when it is at or near a size such that, when formed into a packet for communication, the packet size will be an optimum size for a particular communication link protocol. In another embodiment, the determination is made based on whether a specified or programmable amount of time has elapsed. This ensures that messages are communicated with a specified or programmed period of time. In another embodiment, the determination is made based on whether there is side-band data available to be sent, and if there is sufficient space to add in the side-band data such that the packet size will be an optimum size for a particular communication link protocol. Side-band data could be any data that is not of high urgency to deliver, such as a patch, update, or additional data not yet immediately needed, but which might be needed in the future. In still another embodiment, the determination can be based on a combination of factors, including a specified period of time, packet size, link usage, availability of side-band data, and the like.

If, at block 506, it is determined that the coalesced message is not complete, the method returns to block 502 and another message is received. The next received message can be associated with a different communication protocol, including a different security feature, different compression feature, or any combination thereof. Accordingly, in the illustrated embodiment of FIG. 5, messages associated with different communication protocols can be coalesced into coalesced messages, allowing for more efficient communication between endpoints.

If, at block 506, it is determined that the coalesced message is complete, the method flow moves to block 508 and a packet is formed with the coalesced message. The packet is formed based on a protocol associated with a communication link. At block 510 the packet is communicated via the communication link.

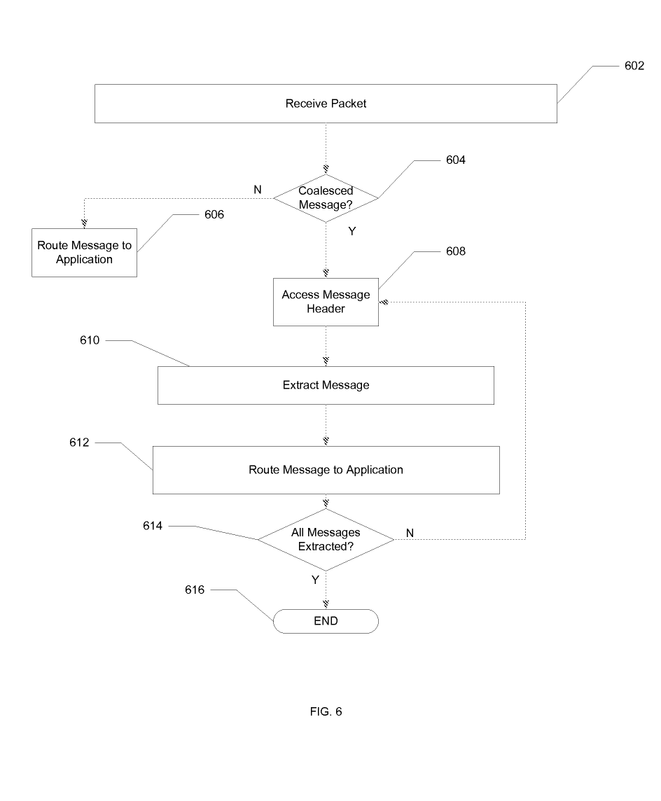

Referring to FIG. 6, a flow diagram of a method of de-coalescing messages in accordance with one embodiment of the present disclosure is illustrated. At block 602 a packet is received at an endpoint via a communication link. At block 604, the endpoint determines whether the packet includes a coalesced message. This determination can be based on a message header of the packet or other information. If the packet does not include a coalesced message, the method flow moves to block 606 and the message is extracted from the packet and routed to an application to which the message is targeted.

If, at block 604, it is determined that the message in the packet is a coalesced message, the coalesced message can include individual messages whereby the individual messages are associated with different communication protocols, including security features, compression features and the like. In addition, each individual message can be associated with a different communication port. Accordingly, the method flow moves to block 608 and a message header of the first individual message in the coalesced message is accessed. The message header can identify the size of the individual message, the communication protocol associated with the individual message, the port number associated with the individual message, and the like. At block 610 the message is extracted based on the accessed header.

At block 612, the extracted message is routed to the connection that is the target of the message which the given application can then receive the message as a standard connection interface such as sockets. In an embodiment, this routing can be based upon a port number indicated in the accessed message header. At block 614, it is determined whether all messages in the coalesced message have been extracted. If not, the method flow returns to block 608 and the message header for the next individual message in the coalesced message is accessed. If all of the individual messages have been extracted, the method ends at block 616.

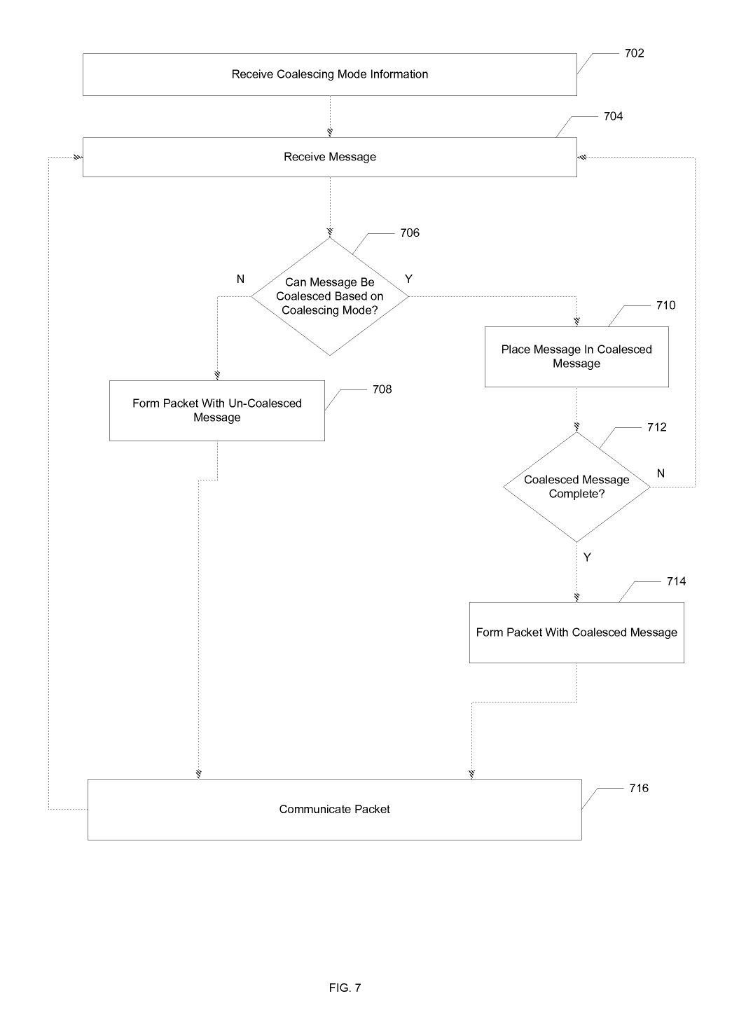

FIG. 7 illustrates a flow diagram of a particular embodiment of a method of coalescing messages. At block 702, coalescing mode information is received at a coalescing module. The coalescing module can be a hardware or software module, and can receive the coalescing mode information via a standard or specialized software or hardware interface. The coalescing mode information indicates which messages can be coalesced with which other messages, based on the connections associated with each method. Thus, the coalescing mode information can indicate that coalescing is disallowed for all messages, allowed for all messages, or allowed only for those messages associated with a particular subset of connections between communication endpoints. In addition, the coalescing mode information can indicate that coalescing is allowed for different subsets of connections, such that messages associated with a first subset of connections can be coalesced with other messages associated with the first subset, but not coalesced with messages associated with a second subset of connections between endpoints.

At block 704, a message is received at the coalescing module. At block 706, the coalescing module determines, based on the coalescing mode information, whether the message can be coalesced with other messages. In an embodiment, this determination is made based on the connection associated with the message. If, based on the coalescing mode information, the message cannot be coalesced with other messages, the method flow moves to block 708 and a packet is formed with the received un-coalesced message. The method flow moves to block 716 and the packet is communicated to the endpoint. The method returns to block 704 and the coalescing module awaits another message.

If, at block 706, it is determined that the message can be coalesced, the method flow moves to block 710 and the received message is placed into a coalesced message. The method flow moves to block 712 and it is determined whether the coalesced message is complete. If not, the method flow returns to block 704 and the coalescing module awaits another message. If the coalesced message is complete, the method flow moves to block 714 and a packet is formed with the coalesced message. The method proceeds to block 716 and the packet is communicated to the endpoint.

It will be appreciated that, in other embodiments, the determination whether a coalesced message is complete is not made in response to placing a message in the coalesced message, but rather is based on other criteria, such as whether a specified amount of time has expired.

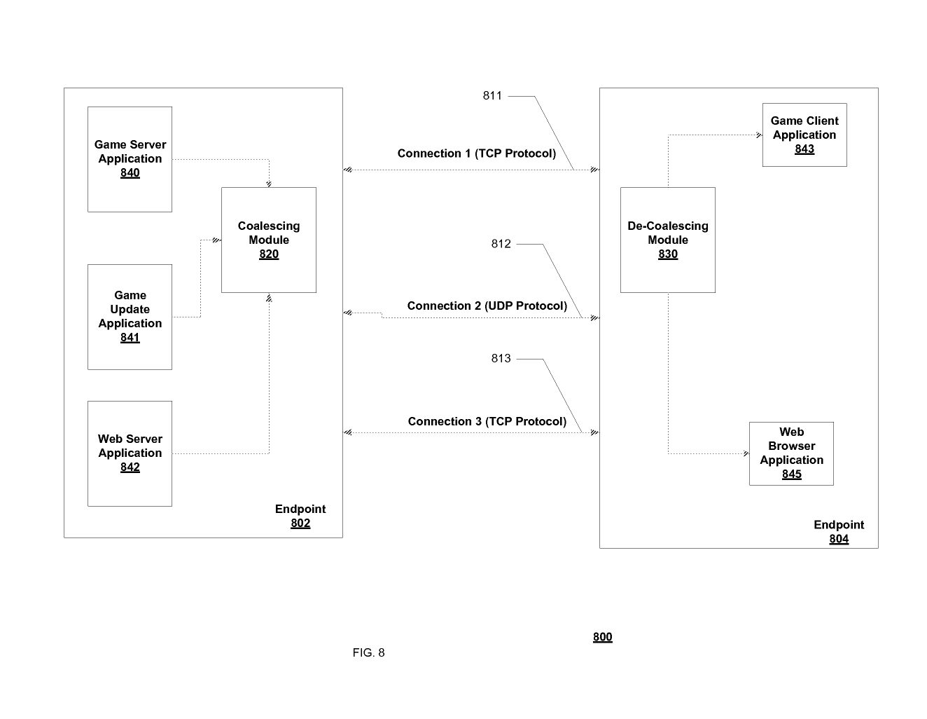

Referring to FIG. 8, a block diagram of a particular embodiment of a data processing system 800, including endpoints 802 and 804, is illustrated. In the illustrated embodiment, the endpoint 802 is a computer system configured to operate as a server, while the endpoint 804 is a computer system in a client configuration. In other embodiments, the endpoints 802 and 804 can be computer systems configured as peers in a peer-to-peer (P2P) communication configuration.

As illustrated the endpoint 802 executes a number of different applications, including a game server application 840, a game update application 841, and a web browser application 842. The game server application 840 is configured to provide information to create an online game environment for a game client application executing at a client computer system. The game update application 841 is configured to provide information, such as patch or update information, to modify a game client application so that it can interact with the game server application 840 in a specified fashion. The web server application 842 is configured to provide web content for display at a web browser application.

The endpoint 802 also includes a coalescing module 820, configured as described above with respect to FIGS. 1-7. The coalescing module 820 can be a software module, as described with respect to FIG. 4, or a hardware module, as described with respect to FIG. 3. The coalescing module 820 is configured to receive messages from the applications 840, 841, and 842, and coalesce messages based on mode control information provided by the applications, by an operating system (not shown) or other module.

The endpoint 804 is configured to execute a game client application 843 and a web server application 845. The game client application 843 is configured to display an online game environment based on information received from a game server application. In addition, the game client application is configured to modify one or more aspects of the application based on patch or update information received from a game update application. The web browser application 845 is configured to display web content received from a web server application.

In the illustrated embodiment, the endpoint 802 can provide information to the endpoint 804 via a number of connections, including connection 811 (labeled “Connection 1”), connection 812 (labeled “Connection 2”), and connection 813 (labeled “Connection 3”). It will be appreciated that the connections 811-813 can be virtual or logical connections set up by the endpoints 802 and 804, and that communications over each connection can be communicated via the same physical connections. A connection can be requested by an application executing at one of the endpoints 802 and 804, and can be set up by an operating system (not shown) or other module executing at the associated endpoint.

Each of the connections 811-813 can be associated with communications from a different application, or type of data provided by an application, at the endpoint 802. In the illustrated embodiment, the connection 811 is associated with communications provided by the game server application 840, the connection 812 is associated with the game update application 841, and the connection 813 is associated with the web browser application 842. In addition, each connection is associated with a particular communication protocol, such that communications provided over a connection complies with the associated protocol. In the illustrated embodiment, the connections 811 and 813 are each associated with a TCP protocol, while the connection 812 is associated with a UDP protocol.

In the illustrated embodiment, the coalescing module 820 is configured, based on received mode control information, to coalesce messages provided by the game server application 840 and the game update application 841, and to not coalesce messages received from the web browser application. Accordingly, in operation, the coalescing module 820 receives a message from the game server application and the game update application. In response, the coalescing module 820 coalesces the messages into a coalesced message, and forms a packet with the coalesced message.

In the illustrated embodiment, the coalescing module 820 can select a connection with which to communicate the packet. The coalescing module 820 can make the selection based on a variety of criteria. For example, if the coalescing module 820 determines that one of the messages is associated with an ordered protocol, such as TCP, and one of the messages is associated with a non-ordered protocol, such as UDP, the coalescing module can select the connection associated with the ordered protocol, in order to preserve message order. Thus, in the illustrated example, the coalescing module 820 can communicate the packet including the coalesced message via connection 811, using a TCP protocol. Accordingly, although the message received from the game update application 841 is associated with a UDP protocol, it is actually communicated to the endpoint 804 using the TCP protocol associated with connection 811 and messages received from the game server application 840.

In addition, in response to receiving a message from the web browser application 842, the coalescing module 820 can determine, based on the mode control information, that the message is not to be coalesced. In response, the coalescing module 820 forms a packet including the non-coalesced message, and communicates it via the connection 813.

It will be appreciated that, in the above example, messages from the game server application 840 and game update application 841 are coalesced and communicated via the connection 811. Thus, in some situations, no packets are communicated via the connection 812. Nevertheless, the connection 812 may still be established between the endpoints 802 and 804. This allows the coalescing module 820 to be inserted into the communication path between the endpoints 802 and 804 without redesign of the applications 840-842 or extensive re-design of an operating system executing at the endpoint 802.

The de-coalescing module 830 is configured to receive packets from each of the connections 811-813 and determine whether the packet includes a coalesced or non-coalesced message. In the event the packet includes a non-coalesced message, the de-coalescing module 830 extracts the message from the packet and provides the message to the associated application. Thus, in the case of a message communicated via the connection 813 (i.e. a message provided by the web server application 842), the de-coalescing module 830 will extract the message from the associated packet and provide the message to the web browser application 845.

In the event a received packet includes a coalesced message, the de-coalescing module will extract each coalesced message from the packet and provide the extracted messages to the associated application, together with an indication of the connection associated with the message. Accordingly, if the de-coalescing module 830 receives a packet having a coalesced message including messages from both the game server application 840 and the game update application 841, the de-coalescing module 830 extracts each message and provides the extracted messages to the game client application 840 as if the each message had been received via the connection associated with the application that provided the message. That is, the de-coalescing module 830 will provide an extracted message from the game update application 841 to the game client application 843 such that it appears to the game client application 843 that the message was communicated via the connection 812, and will provide an extracted message from the game server application 840 such that it appears to the game client application 843 that the message was communicated via the connection 812. Thus, the fact that the messages were coalesced, and that a particular message may have actually been communicated via a different connection, is transparent to the game client application 843. This allows messages to be coalesced and communicated without redesign of the game client application 843.

Thus, in the illustrated embodiment of FIG. 8, coalesced messages can be used to provide both game environment information to the game client application 843, allowing a user to play an online game, and also can be used to provide patch or update information, so that the game client application 843 stays up-to-date. By allowing different types of messages to be coalesced, efficiency of communication between the endpoints 802 and 804 is enhanced.

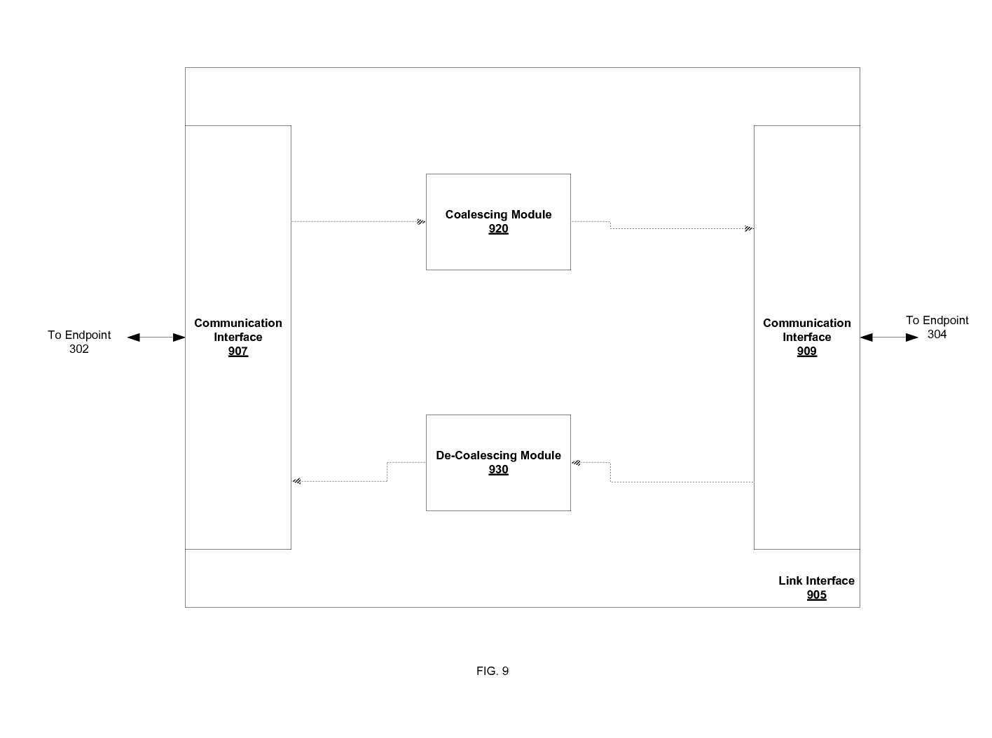

Referring to FIG. 9, a block diagram of a particular embodiment of a link interface 905, corresponding to the link interface 305 of FIG. 3, is illustrated. The link interface 905 includes a communication interface 907, a communication interface 909, a coalescing module 920, and a de-coalescing module 930. The communication interface 907 is configured to provide a physical interface for communications to and from the endpoint 302, and can be a bus interface, a network interface, and the like. The communication interface 909 is configured to provide a physical interface for communications to and from the endpoint 304, and can be a bus interface, a network interface, and the like.

In operation, the communication interface 907 receives messages from the endpoint 302 and provides the messages to the coalescing module 920, which determines whether a received message can be coalesced, as described above. The coalescing module 920 also coalesces received messages, as described above, and forms packets for both coalesced and non-coalesced messages. The packets are provided to the communication interface 909 for communication to the endpoint 304.

The communication interface 909 receives packets from the endpoint 304 and provides the packets to the de-coalescing module 930. The de-coalescing module 930 determines whether a received packet includes a coalesced message and if so, extracts the individual messages, as described above. The de-coalescing module 930 can also extract non-coalesced messages from received packets. The extracted messages are each provided to the communication interface 907 for communication to the endpoint 302.

The above disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving a first message associated with a first communication protocol;
receiving a second message associated with a second communication protocol;
forming a first packet including the first message and the second message; and
communicating the first packet.

2. The method of claim 1, wherein the second communication protocol is different from the first.

3. The method of claim 1, further comprising:
receiving a third message associated with a third communication protocol; and
wherein forming the first packet comprising forming the first packet including the third message.

4. The method of claim 1, wherein forming the first packet comprises:
forming the first packet in response to determining the first message is associated with a first communication connection and the second message is associated with a second communication connection.

5. The method of claim 1, wherein forming the first packet comprises:
determining that coalescing mode information indicates the first message and the second message can be coalesced.

6. The method of claim 1, further comprising:
receiving a third message;
forming a second packet including the third message, the third message not coalesced with another message; and
communicating the second packet.

7. The method of claim 1, wherein the first communication protocol and the second communication protocol are transport layer protocols.

8. The method of claim 1, wherein the first communication protocol is selected from the group consisting of Transmission Control Protocol (TCP), User Datagram Protocol (UDP), Real-Time Transport Protocol (RTP), Signaling Connection and Control Part (SCCP), Sequenced Packet Exchange (SPX), Stream Control Transmission Protocol (SCTP), Network File System (NFS), Server Message Block (SMB), IPv4, IPv6, IPSec, Secure Sockets Layer (SSL), Internetwork Packet Exchange (IPX), Connectionless Networking Protocol (CLNP).

9. The method of claim 1, wherein the first communication protocol is associated with a different security feature than the second communication protocol.

10. The method of claim 1, wherein the first communication protocol is associated with a different compression feature than the second communication protocol.

11. The method of claim 1, wherein the first message is targeted to a first port and the second message is targeted to a second port.

12. The method of claim 1, wherein the first communication protocol is an ordered communication protocol, and the second communication protocol is a non-ordered communication protocol.

13. The method of claim 12, wherein communicating the first packet comprises communicating the first packet via a connection associated with the first communication protocol.

14. The method of claim 1, wherein receiving the first message comprises receiving the first message from a first processor at an interface device and receiving the second message comprises receiving the second message at the interface device.

15. The method of claim 14, wherein the interface device comprises a network interface.

16. A method, comprising:
receiving a first packet;
in response to determining the first packet includes a coalesced message:
extracting a first message of the coalesced message from the first packet, the first message associated with a first communication protocol; and
extracting a second message of the coalesced message from the first packet, the second message associated with a second communication protocol.

17. The method of claim 16, further comprising:
providing the first message to a first connection; and
providing the second message to a second connection.

18. The method of claim 16, wherein the first communication protocol is different from the second communication protocol.

19. The method of claim 16, further comprising determining a message order between the first message and the second message based on a header.

20. The method of claim 16, further comprising determining a message order between the first message and a third message based on a header, wherein the third message is a non-coalesced message.

21. A device comprising:
a first interface configured to receive from a first processor a first message associated with a first communication protocol and a second message associated with a second communication protocol;
a coalescing device configured to coalesce the first and second messages to form a coalesced message, and configured to provide a first packet including the coalesced message; and
a second interface configured to communicate the first packet to an endpoint.

22. The device of claim 21, wherein the first interface comprises a bus interface.

23. The device of claim 21, wherein the second interface comprises a network interface.

24. The device of claim 21, wherein the coalescing device is configured to determine an order of the first message and the second message, and is configured to form the packet to include a header indicating the order.

25. The device of claim 21, wherein the coalescing device is configured to coalesce the first and second messages in response to determining that mode control information indicates the first and second messages can be coalesced.

26. A device, comprising:
a first interface configured to receive a packet, the packet including a coalesced message;
a de-coalescing device configured to extract a first message and a second message from the coalesced message, the first message associated with a first communication protocol and the second message associated with a second communication protocol; and
a second interface configured to communicate the first message and the second message to an endpoint.

27. The device of claim 26, wherein the de-coalescing device is further configured to determine an order of the first message and the second message based on header information of the packet.
